(19) United States
(12) Patent Application Publication
(10) Pub. No.: US 2011/0023099 A1
(43) Pub. Date: Jan. 27, 2011

(54) USER TERMINAL WITH IDENTITY SELECTOR AND METHOD FOR IDENTITY AUTHENTICATION USING IDENTITY SELECTOR OF THE SAME

(76) Inventors: Seunghyun Kim, Daejeon (KR); Daeseon Choi, Daejeon (KR); Deokjin Kim, Daejeon (KR); Soohyung Kim, Daejeon (KR); Jonghyouk Noh, Daejeon (KR); Kwansoo Jung, Daejeon (KR); Sangrae Cho, Daejeon (KR); Youngseob Cho, Daejeon (KR); Jinman Cho, Daejeon (KR); Seunghun Jin, Daejeon (KR)

Correspondence Address: AMPACC Law Group, PLLC, 6100 219th Street SW, Suite 580, Mountlake Terrace, WA, 98043, US

(21) Appl. No.: 12/934,262

(22) PCT Filed: Mar. 31, 2009
(86) PCT No.: PCT/KR09/01630

§ 371 Date: Sep. 23, 2010

(30) Foreign Application Priority Data
Mar. 31, 2008 (KR) 10-2008-0029875
Mar. 31, 2008 (KR) 10-2008-0029877
Dec. 29, 2008 (KR) 10-2008-0135425

(51) Int. Cl. H04L 9/32; G06F 21/00

(52) U.S. Cl. 726/5

(57) ABSTRACT

The present invention relates to a user terminal (100) with an identify selector and a method for an identity authentication using the identify selector of the same, in which when a web service makes a request to a web service providing server (300) using a virtual personal identification information issued from an identity authentication server (200), a corresponding user identity is authenticated between the user terminal and the identity authentication server (200) using the identity selector according to the request of the web service providing server (300). The present invention has advantages that it can solve the problem of inputting an ID and password within the range such that the I-PIN or SMAL service protocol is not changed, but the subscribed I-PIN or SAML service providing site cannot be easily copied and a phishing problem by simplifying a log-in process for identity authentication by adding the identity selector.

### TECHNICAL FIELD

The present invention relates to a user terminal with an identify selector and a method for an identity authentication using the identify selector of the same, and more particularly, to a user terminal with an identity selector that performs an identity authentication therethrough to solve the problem during log-in between an identity authentication server and a web service providing server, and a method for identity authentication using the identity selector of the same.

### BACKGROUND ART

A resident registration number, which is a unique number assigned to people from different countries, is used to identify a person when using an on-line environment as well as an off-line environment. When subscribing to a website, the website requests that a user indispensably inputs his or her resident registration number during a registration process of a user. However, as the user's resident registration number is managed in a database of various websites, various problems have arisen in that the resident registration number is leaked or illegally used, etc.

The use of personal resident registration number and name for online log-in for internet websites have lead to serious misuse thereof; consequently, a virtual personal identification information service such as an Internet-Personal Identification Number (I-PIN) or a Government-Personal Identification Number (G-PIN) has been created by government agencies in order to protect personal information, which allow the user an alternative method of using the internet such as a virtual resident registration number. The resident registration number is a unique identification number that is permanently designated to identify a person, whereas the I-PIN or the G-PIN is a user identification number that is given by trusted third party for temporarily identifying a person.

However, the virtual personal identification information service has problems related to user convenience and security. First, in view of user convenience, it is problematic in selecting and logging-in the I-PIN site or G-PIN site. Currently, there are five sites that support the virtual personal identification information service, wherein similar interfaces are provided but the actual driving method is different for each site. The virtual personal identification information service is used as an alternative to the resident registration number, such that the user can use only the corresponding service when subscribing to a single website.

Further, the respective websites additionally propose their preferred virtual personal identification information services to the user, which then allow the user to select other I-PIN or G-PIN site when he or she wishes to use other I-PIN or G-PIN site. This causes inconvenience to the user because the user should remember the site he or she has subscribed therefrom in order to go directly to the corresponding site. Also, the I-PIN or G-PIN site requests high-level security, different from general websites, which require a complex ID and password, Therefore, the user should remember the log-in information used in the I-PIN site, which may also cause inconvenience.

In view of security, the virtual personal identification information service may also have problems with phishing or keyboard hacking. In other words, an illegal website may deceive the user by making an optional I-PIN or G-PIN log-in page and allowing the user to input his or her log-in information. The current virtual personal identification information service is driven as a popup page to allow the user to input log-in information. However, based on only the information shown on the popup page the user cannot determine whether the corresponding service is legal. Therefore, there is a problem in that the user cannot determined if the service site information to which he or she has subscribed and the log-in information have been illegally used. Meanwhile, keyboard hacking occurs while the ID and the password are input into the corresponding site, such that the log-in information may be exposed.

### DISCLOSURE OF INVENTION

### Technical Problem

An object of the present invention is to provide a user terminal with an identity selector that solves the problem of in inputting an ID and password within the range such that the I-PIN or G-PIN service protocol is not changed, but the subscribed I-PIN or G-PIN site cannot be easily copied, and preventing a phishing problem by simplifying a log-in process for identity authentication by adding the identity selector, and a method for identity authentication using the identity selector of the same.

Another object of the present invention is to provide a user terminal with an identity selector that uses previously established link information when performing a log-in by using the identity selector to perform an identity authentication procedure, making it possible to safely provide security in order to prevent phishing without using a separate keyboard input, to prevent keyboard hacking, and a method for identity authentication using the identity selector of the same.

### Technical Solution

In order to accomplish the above object, according to an embodiment of the present invention, there is provided a user terminal with an identify selector that provides identity information for user identity authentication between an identity authentication server and a web service providing server, including: an identity management module that stores and manages information of the identity authentication server that issues virtual personal identification information for a corresponding user and the corresponding user identity information; and when a web service using the virtual personal identification information is requested to the web service providing server, an identity selector module that controls a driving of the identity selector that provides authentication information generated based on the corresponding user identity information stored in the identity management module to the identity authentication server, while the corresponding user identity authentication is performed between the user terminal and the identity authentication server according to the request from the web service providing server.

The virtual personal identification information includes at least one of Internet-Personal Identification Number (I-PIN), Government Personal Identification Number (G-PIN), and Security Assertion Markup Language (SAML)-based authentication information.

The user identity information includes at least one of log-in information and the virtual personal identification information issued from the identity authentication server, and the corresponding user personal information.

The user identity information is stored to correspond to each of the identity authentication server that issues the virtual personal identification information to the corresponding user.

When a predetermined web service makes a request to the web service providing server using the virtual personal identification information, the identity selector module is driven according to the request of the identity authentication server to which the identity authentication is requested by the web service providing server. Meanwhile, when a predetermined web service makes a request to the web service providing server using the virtual personal identification information, the identity selector module is driven according to the request of the web service providing server.

The identity selector module outputs a list of the identity authentication server registered in the identity management module and requests a connection to any one identity authentication server selected from the list of the identity authentication server.

When the corresponding user identity authentication is completed in the identity authentication server, the identity selector transfers the result of the identity authentication provided from the identity authentication server to the web service providing server.

Meanwhile, in order to accomplish the above object, according to an embodiment of the present invention, there is provided a method for an identity authentication using an identity selector of a user terminal that performs identity authentication using the identity selector provided in the user terminal between an identity authentication server and a web service providing server including: requesting a web service to the web service providing server by using virtual personal identification information issued from the identity authentication server; when the web service providing server requests a corresponding user identity authentication from the web service providing server, driving the identity selector by request of the identity authentication server; transmitting an authentication information from the identity selector to the identity authentication server, the authentication information being generated based on the corresponding user identity information registered by the corresponding identity authentication server; and when the corresponding user identity authentication is completed in the identity authentication server using the identity information transmitted in the transmitting the authentication information, receiving the requested service by transmitting the result of the identity authentication of the identity authentication server to the web service providing server.

The virtual personal identification information includes at least one of Internet-Personal Identification Number (I-PIN), Government Personal Identification Number (G-PIN), and Security Assertion Markup Language (SAML)-based authentication information.

The user identity information includes at least one of log-in information and the virtual personal identification information issued from the identity authentication server, and the corresponding user personal information.

The user identity information is stored to correspond to each of the identity authentication server that issues the virtual personal identification information to the corresponding user.

The method for the identity authentication using the identity selector of the user terminal further includes: before requesting the web service, connecting a corresponding user terminal to the identity authentication server; providing the corresponding user identity information to the identity authentication server and being performed a corresponding user identity authentication by the identity authentication server; and after the identity authentication of the identity authentication server is completed, storing log-in information and virtual personal identification information issued from the identity authentication server in the corresponding user terminal.

The method for the identity authentication using the identity selector of the user terminal further includes: after the driving the identity selector, extracting and outputting a list of the identity authentication server stored in the corresponding user terminal; and requesting connection to ones selected among the list of the output identity authentication server.

The transmitting the authentication information further includes: when the selected identity authentication server is different from an identity authentication server from which the web service providing server requested the identity authentication, transmitting the result of the identity authentication of the corresponding identity authentication server from the identity selector to the identity authentication server to which the identity authentication is requested by the web service providing server; and based on the transmitted result of the identity authentication, providing the result of the identity authentication issued from the identity authentication server to which the identity authentication is requested by the web service providing server to the web service providing server.

### ADVANTAGEOUS EFFECTS

The present invention as described above has advantages in that it can solve the troublesome of inputting an ID and password in the I-PIN or SAML service, the problem that the subscribed I-PIN or SAML service provider is hardly remembered, including the phishing problem, and the security problem.

Further, the present invention has an advantage in that the identity authentication procedure can be processed completely internally by only allowing the identity information to be used which is selected by the identity selector, removing the step of when the user selects the I-PIN or SAML service provider and the step of when the user moves to the I-PIN or SAML service provider for the authentication procedure. At this time, communication and authentication with the I-PIN or SAML service provider is made in a reliable manner using the identity selector rather than the site, making it possible to solve the phishing and security problems.

In addition, it is advantageous for the user in that the problems in selecting the I-PIN or SAML service provider to which himself or herself is subscribed to, and the problem in moving to the I-PIN or SAML service provider to perform the authentication procedure is resolved. Here, the identity selector, which replaces a portion where the I-PIN or SAML service provider's popup drives, is advantageous in that it is a progressive in view of security and user convenience at the same time the conventional I-PIN protocol or SAML protocol can be applied without being changed.

Moreover, the present invention requires minimum modification, wherein the conventional i-PIN service client module, service module, and identity selector driving module may be mounted. At this time, although there is no identity selector driving module, if the I-PIN or SAML service provider can drive the identity selector, he or she can easily use the present invention.

### BRIEF DESCRIPTION OF DRAWINGS

FIG. 1 is a view showing a constitution of an identity authentication system to which the present invention is applied;

FIG. 2 is a view showing a constitution of a user terminal according to an embodiment of the present invention;

FIGS. 3 to 6 are illustrative views showing an identity authentication operation according to the present invention; and

FIGS. 7 to 10 are flowcharts showing a method for identity authentication according to the present invention.

### BEST MODE FOR CARRYING OUT THE INVENTION

Hereinafter, the preferred embodiments of the present invention will be described in detail with reference to the accompanying drawings.

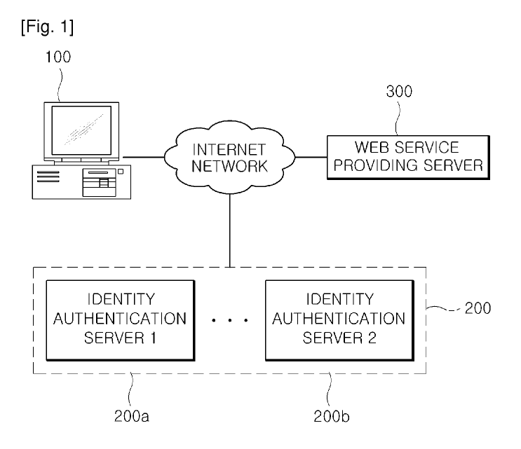

FIG. 1 is a schematic view showing a constitution of an identity authentication system to which an identity authentication apparatus with an identity selector according to the present invention is applied. The identity authentication system according to the present invention includes a user terminal 100, an identity authentication server 200, and a web service providing server 300, as shown in FIG. 1. At this time, the user terminal 100, the identity authentication server 200, and the web service providing server 300 are connected to each other through an internet.

The user terminal 100 is a personal terminal that is used in allowing a user to be connected to the identity authentication server 200 to receive an identity authentication service or in allowing the user to be connected to the web service providing server 300 to receive a web service.

The user terminal 100 is stored with user identify information. Here, the user identification information includes subscriber information such as ID and password, etc. issued from the corresponding identity authentication server 200 when subscribing to the identify authentication server 200, information such as an address of the corresponding identity authentication server 200, etc., and user personal information.

Also, the user terminal 100 is provided with an identity selector module 150 that is connected to the identity authentication server 200 to perform a user identity authentication procedure.

When the user terminal 100 requests identity authentication to the identity authentication server 200, the identity selector module 150 is driven by the identity authentication server 200 and at this time, an identity selector is operated by the identity selector module 150. Therefore, an identity authentication procedure between the user terminal 100 and the identity authentication server 200 is performed by the identity selector. Here, while the identity authentication procedure is performed, the identity selector provides user identity information registered in the user terminal 100 to the identity authentication server 200, without exposing it to the outside.

In other words, while the identity authentication procedure between the identity authentication server 200 and the user terminal 100 is performed, the identity selector automatically provides the corresponding user identity information to the identity authentication server 200 so that there is no need to receive separate information from the user. Therefore, there is no need for the user to input separate user information one by one, making it possible to improve convenience and the exposure of user information by hacking of an input apparatus such as a keyboard, etc., is prevented. Thus, it is possible to provide a more stable user authentication procedure.

Here, the identity selector may be implemented in combination with a web browser or in a stand-alone application.

Meanwhile, the identity authentication server 200 is stored with subscription information such as personal information registered when the user initially subscribes and log-in information, etc., and information showing whether an authentication session is held according to the user identity authentication, etc. According to the user terminal 100's requests, the identity authentication server 200 performs the corresponding user identity authentication based on the stored user identity information.

Here, the identity authentication server 200 may be a server that issues an Internet-Personal Identification Number (I-PIN) or a Government-personal Identification Number (G-PIN), that is a virtual personal identification number that can identify the user after the corresponding user identity authentication, is performed. Also, the identify authentication server 200 may be a server that provides a Security Assertion Markup Language (SAML) service.

For example, the identity authentication server 200 may be a server for private credit bureaus, a server for an information security company, or a server for a public agency. At this time, the user 100 receives an identity authentication service selected through any one identity authentication server 200 among the plurality of identity authentication servers 200.

Also, the identity authentication server 200 includes an identity selector control module 250 that controls the identity selector of the user terminal 100. When there is an identity authentication request to the identity authentication server 200 from the user, the identity selector control module 250 drives the identity selector module 150 of the corresponding user terminal 100 and performs the corresponding user identity authentication procedure through the information exchange with the identity selector operated at this time. At this time, the identity authentication server 200 provides the result of the corresponding user identity authentication to the user terminal 100.

In the case of the identity authentication is requested by the web service providing server 300, the identity authentication server 200 transfers the result of the identity authentication to the web service providing server 300 through the web browser of the user terminal 100. Therefore, the web service providing server 300 provides the service requested by the corresponding user terminal 100 according to the authentication result of the identity authentication server 200.

Meanwhile, when there is a predetermined web service request such as a member subscription service, etc. using the virtual personal identification number from the user terminal 100, the web service providing server 300 may request the corresponding user identity authentication information from the identity authentication server 200. At this time, the web service providing server 300 can request the identity authentication to the identity authentication server 200 only through the web browser of the user terminal 100. At this time, the web service providing server 300 may further include a separate identity selector driving module 350. However, only when the identity selector is not driven by the identity authentication server 200, the web service providing server 300 allows the identity selector driving module 350 to be driven. The identity selector driving module 350 is used in driving the identity selector of the user terminal 100.

When the corresponding user identity authentication information is received from the identity authentication server 200, the web service providing server 300 verifies the user identity using the received identity authentication information. The web service providing server 300 determines whether or not the requested service is provided to the corresponding user terminal 100 according to the result of the identity authentication, and provides the requested service to the user terminal 100 when the corresponding service is determined to be provided.

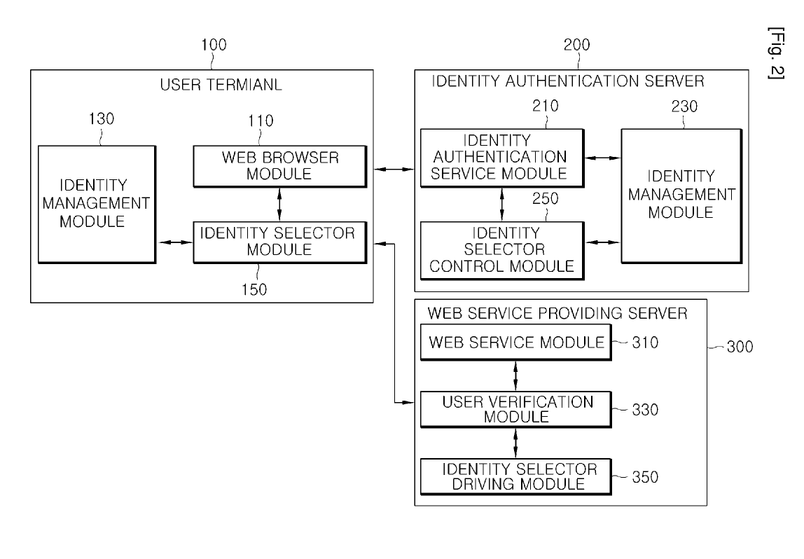

In this regard, the constitution of the identity authentication system according to the present invention will be described in more detail with reference to FIG. 2.

First, the user terminal 100 includes a web browser module 110, an identity management module 130, and an identity selector module 150. The web browser module 110 is a module that is driven when there is a request from the user terminal 100 to be connected to a web. Therefore, a web browser is operated by the web browser module 110 and thus, the user terminal 100 is connected to the identity authentication server 200 and the web service providing server 300 through the web browser.

The identity management module 130 stores and manages user identity information. At this time, the user identity information managed by the identity management module 130 includes subscriber information such as ID and password, etc. issued from the corresponding identity authentication server 200 when subscribing to the identify authentication server 200, information such as an address of the corresponding identity authentication server 200, etc., and user personal information, as mentioned above. Here, the user identity information may be one provided from the identity authentication server 200, wherein partial information may be one input directly from the user.

While the identity authentication procedure is performed between the user terminal 100 and the identity authentication server 200 through the identity selector, the identity management module 130 provides the information stored identity authentication server 200 by the requests from the identity selector.

Also, when the user requests the authentication service from different objects through the web browser, the identity management module 130 stores the corresponding authentication information. Thereafter, when the corresponding object performs the authentication service, the identity management module 130 may also provide the stored authentication information to the corresponding object.

In other words, when the identity authentication service is performed from an identity authentication server 1 200a and an identity authentication server 2 200b, the identity management module 130 stores the authentication information from the identity authentication server 1 200a and the identity authentication server 2 200b. Thereafter, when the identity authentication service is to be performed again from the identity authentication server 1 200a and the identity authentication server 2 200b, the identity management module 130 may provide the stored authentication information to the corresponding identity authentication server 200.

The identity selector module 150 is a module that is operated in order to perform the identity authentication of the identity authentication server 200 when the user intends to use the web service, as aforementioned. At this time, the identity selector module 150 may be provided from the identity authentication server 200 at the time of subscribing to the identity authentication server 200, or from the user request after the subscription is completed.

When there is a request of identity authentication information from the web service providing server 300 in which the user intends to use the web service, the identity selector module 150 is driven by the identity authentication server 200 to perform the corresponding user identity authentication. At this time, the identity selector is performed as the identity selector module 150 is driven.

The identity selector extracts at least one information of identity authentication server 200 from the identity management module 130 prior to performing the identity authentication procedure and provides it to the user. At this time, the extracted at least one information of identity authentication server 200 may be output in a list. The identity selector being selected by the user receives any one identity authentication server 200 to perform the identity authentication from the list of the identity authentication server provided by the identity selector.

If the identity authentication server 200 to perform the identity authentication is selected by the user, the identity selector requests a connection to the selected identity authentication server 200. At this time, the selected identity authentication server 200 is basically the identity authentication server 200 that drives the identity selector according to the requests from the web service providing server 300, but other identity authentication servers 200 may also be selected.

Thereafter, when there is a request of the user identity information from the identity authentication server 200 while the user identity authentication is performed, the identity selector extracts the corresponding user identity information from the identity management module 130. At this time, the identity selector generates authentication information on the identity authentication server 200 using the identity information extracted from the identity management module 130.

The identity selector provides the authentication information generated using the corresponding user identity information to the identity authentication server 200. Also, the identity selector transfers the result of the identity authentication of the identity authentication server 200 to the web service providing server 300 through the web browser. Therefore, the web service providing server 300 that receives the result of the identity authentication from the identity selector verifies the user identity using the received result of the identity authentication.

When the identity authentication procedure of the identity authentication server 200 is completed, the operation of the identity selector is automatically completed. Therefore, user information is prevented from being exposed to the outside.

Meanwhile, the identity authentication server 200 includes an identity authentication service module 210, an identity management module 230, and an identity selector control module 250.

The user terminal 100 may request to subscribe to the identity authentication server 200 after being connected to the identity authentication server 200 through the web browser, in order to use the identity authentication service. At this time, the identity authentication service module 210 issues a virtual personal identification number for the corresponding user based on the identification information input by the user or provided from the identity selector of the user terminal 100. At this time, the issued virtual personal identification number may be I-PIN, G-PIN or public I-PIN, etc. or may be a SAML-based identification number. Also, the identity authentication service module 210 issues ID and password for the registered user's log-in.

The identity management module 230 registers the information input by the corresponding user in order to subscribe to the identity authentication server 200 and the issued information from the identity authentication service module 210, etc. When there is a request for the identity authentication service from the corresponding user, the identity management module 230 provides the registered information to the identity authentication service module 210.

Thereafter, when there is a request for the corresponding user identity authentication information from the web service providing server 300 through the web browser of the user terminal 100, the identity authentication service module 210 performs the corresponding user identity authentication using the authentication information provided from the identity selector of the user terminal 100. At this time, the identity authentication service module 210 controls the operation of the identity selector control module 250. In other words, when intending to perform the user identity authentication service, the identity authentication service module 210 controls the operation of the identity selector control module 250 to be driven the identity selector module 150 of the user terminal 100.

Therefore, the identity authentication service module 210 receives the authentication information generated based on the user identity information from the identity selector of the user terminal 100 and performs the corresponding user identity authentication. At this time, the identity authentication service module 210 compares the authentication information provided from the identity selector of the user terminal 100 with the user information registered in the identity management module 230 and perform the identity authentication according to result of above comparison.

If the identity authentication is completed, the identity authentication service module 210 provides the result of the identity authentication to the web service providing server 300 through the web browser of the user terminal 100. At this time, the identity selector of the user terminal 100 serves to transfer the result of the identity authentication.

Meanwhile, the web service providing server 300 includes a web service module 310 and a user verification module 330.

The web service module 310 serves to provide various web services on a website. In other words, when a user is connected and there is a request for a predetermined web service from the connected user, the web service module 310 provides the requested web service to the corresponding user terminal 100. In the case of a web service that needs the corresponding user identity authentication, if the verification of the corresponding user identity is completed through the user verification module 330, the web service module 310 provides the corresponding web service to the user.

The user verification module 330 is a module that verifies the corresponding user identity when the user identity authentication is needed before the web service is provided to the corresponding user terminal 100 through the web service module 310. In other words, when the user authentication is not needed such as news, etc., the user verification module 330 is not operated. However, when a new user requests a subscription service using a virtual personal identification information, etc. or requests a membership service of the previously subscribed user, the user verification module 330 is driven. At this time, the user verification module 330 requests the corresponding user identity authentication information to the identity authentication server 200 through the web browser connected to the user terminal 100.

The user verification module 330 allows the web service requested through the web service module 310 only when the corresponding user authentication is completed, according to the result of the user identity authentication received from the identity authentication server 200. For example, when the corresponding user identity authentication is performed from the I-PIN issue server and as a result, the I-PIN information corresponding to the corresponding user is received, the user verification module 330 compares the virtual personal identification information input by the user with the I-PIN information received from the I-PIN issue server and verifies the corresponding user identity according to the result of the comparison.

Likewise, when the result of the identity authentication is received from the server that provides a SAML-based service, the user verification module 330 compares the information input by the user with the result of the identity authentication received from the server that provides the SAML-based service and verifies the corresponding user identity according to the result of the comparison. When the verification of the corresponding user identity authentication fails, the user verification module 330 informs the corresponding user thereof.

Therefore, when the user identity authentication is completed by the user verification module 330, the web service module 310 provides the web service requested by the user to the corresponding user terminal 100.

Also, the web service providing server 300 further includes an identity selector driving module 350. The identity selector driving module 350, which is provided from the identity authentication server 200, serves to drive the identity selector module 150 of the user terminal 100. At this time, when the identity selector module 150 of the user terminal 100 is not driven by the identity selector control module 250 of the identity authentication server 200, the identity selector driving module 350 additionally outputs a driving instruction to the identity selector module 150. However, when the identity selector module 150 of the user terminal 100 is driven by the identity selector control module 250 of the identity authentication server 200, the identity selector driving module 350 of the web service providing server 300 may be omitted.

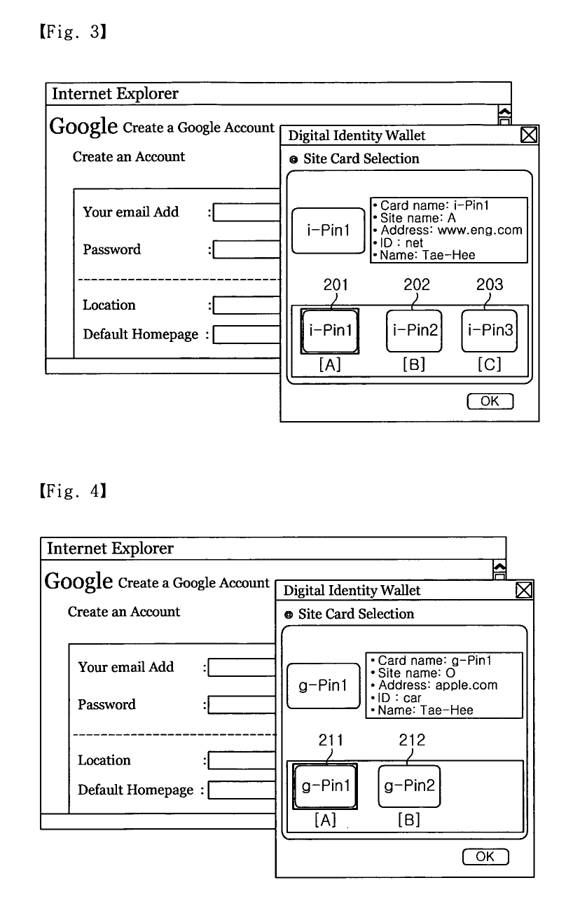

FIGS. 3 to 6 are illustrative views showing the operation of an identity authentication system according to the present invention.

First, FIG. 3, which shows a driving example of an identity selector according to a first embodiment of the present invention, shows the operation to perform the corresponding user identity authentication using the I-PIN issued from the identity authentication server 200. In other words, the identity authentication server 200 of FIG. 3 is the I-PIN issue server by way of example.

Referring to FIG. 3, when there is a request of the identity authentication service through the web browser of the user terminal 100, the I-PIN issue server registers the user identity information input from the corresponding user terminal 100 and issues the I-PIN, the virtual personal identification number.

At this time, the user terminal 100 may receive the I-PIN issued from two or more different I-PIN issue servers other than from one I-PIN issue server. Therefore, if the identity selector is operated by the identity selector module 150, the identity selector extracts and outputs the list of the I-PIN issue server stored in the identity management module 130, that is, i-Pin 1 201, i-Pin2 202, and i-Pin3 203, as shown in FIG. 3. Among others, if any one I-PIN issue server is selected by the user, the identity selector requests connection to the I-PIN issue server selected by the user. Thereafter, the identity selector automatically extracts the corresponding user identity information registered in the identity management module 130, in order to perform the identity authentication procedure of the connected I-PIN issue server. At this time, the identity selector generates the authentication information on the I-PIN issue server using the extracted corresponding user identity information and provides the generated authentication information to the corresponding I-PIN issue server.

FIG. 4, which shows a driving example of an identity selector according to a second embodiment of the present invention, shows the operation to perform the corresponding user identity authentication using the G-PIN issued from the identity authentication server 200. In other words, the identity authentication server 200 of FIG. 4 is the server that provides an authentication service when a SAML service is established, by way of example.

Like the embodiment of FIG. 3, in the embodiment of FIG. 4, when there is a request of the identity authentication service through the web browser of the user terminal 100, a SAML service server registers the user identity information input from the corresponding user terminal 100 and issues the G-PIN, the virtual personal identification number.

At this time, the user may receive the G-PIN issued from two or more different SAML service servers other than from one SAML service server. Therefore, if the identity selector is operated by the identity selector module 150, the identity selector extracts and outputs the list of the SAML service server stored in the identity management module 130, that is, g-Pin 1 211 and g-Pin2 212, as shown in FIG. 4.

Among others, if any one SAML service server is selected by the user, the identity selector requests a connection to the SAML service server selected by the user. Thereafter, the identity selector extracts the corresponding user identity information registered in the identity management module 130, in order to perform the identity authentication procedure of the connected the SAML service server. At this time, the identity selector generates the authentication information on the SAML service server by using the extracted corresponding user identity information and provides the generated authentication information to the corresponding SAML service server.

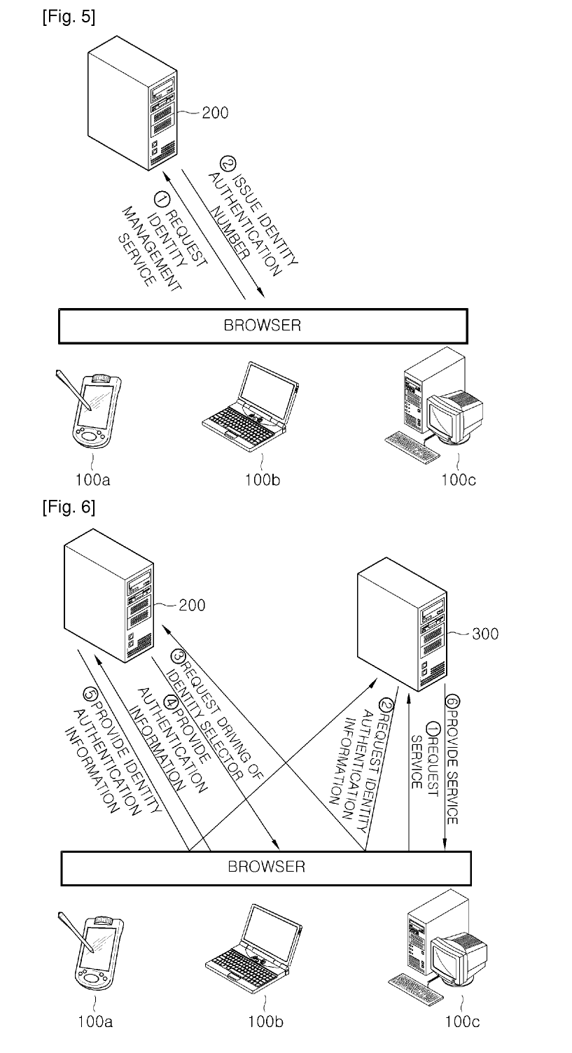

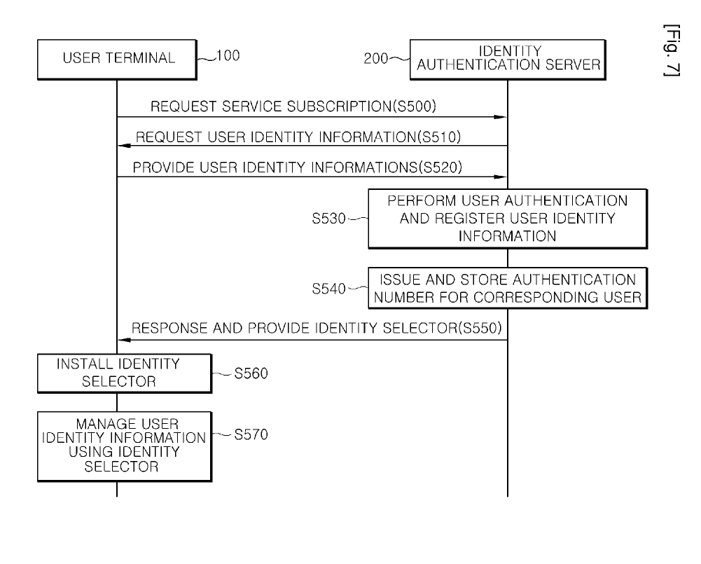

FIGS. 5 and 6 are illustrative views showing the process that the identity authentication procedure is performed in the identity authentication apparatus with the identity selector according to the present invention, as aforementioned.

First, FIG. 5 shows the process that the user registers the identity information in the identity authentication server 200 through the user terminal 100 before performing the identity authentication procedure.

Referring to FIG. 5, as the user terminal 100, which is a terminal that is connectable to the internet, a PDA 100a, a lap-top computer 100b, and a computer 100c, etc. are used. The user drives the web browser module 110 of the user terminal 100 so that the user terminal 100 is connected to the identity authentication server 200 through the web browser operated at that time. Thereafter, the user terminal 100 requests a registration of the identity authentication service to the corresponding identity authentication server 200 according to the user request, as indicated by ‘\textcircled{1}’. At this time, the user terminal 100 provides the user personal information input by the user or stored in the user terminal 100 to the identity authentication server 200.

Therefore, the identity authentication server 200 registers the user personal information provided from the user terminal 100, performs a predetermined authentication procedure, and thereafter, issues the corresponding user identity authentication information, as indicated by ‘\textcircled{2}’. At this time, the identity authentication server 200 transfers the log-in information of the corresponding identity authentication server 200 and the information of the identity authentication server 200, etc. to be transferred to the user terminal 100 through the web browser.

The user terminal registers the identity authentication information issued from the identity authentication server 200 in the identity management module 130.

FIG. 6 is a schematic view showing the operation that the identity authentication procedure is performed among the user terminal 100, the identity authentication server 200, and the web service providing server 300.

Referring to FIG. 6, when the user registered in the identity authentication server 200 in FIG. 5 wishes to use a web service, the web browser module 110 operates the web browser. At this time, the user terminal 100 requests the web service to the web service providing server 300 through the web browser, as indicated by ‘\textcircled{1}’. A membership subscription service of a specific website may be represented by way of example. At this time, the web service providing server 300 that receives the request of the web service from the user terminal 100 requests the corresponding user identity authentication information to the identity authentication server 200 through the web browser of the user terminal 100, as indicated by ‘\textcircled{2}’.

At this time, the identity authentication server 200 that receives the request of the user identity authentication information from the web service providing server 300 requests a driving of the identity selector to the corresponding user terminal 100, as indicated by ‘\textcircled{3}’. In the user terminal 100, the identity selector module 150 is driven according to the request from the identity authentication server 200 and the identity selector is operated by the identity selector module 150. The identity selector extracts the information of the identity authentication server 200 stored in the identity management module 130 of the user terminal 100 to provide it to the user, and request a connection with the identity authentication server 200 selected by the user at this time. However, the corresponding process is omitted from the embodiment of FIG. 6.

Also, the identity selector extracts the user identity information stored in the identity management module 130 of the user terminal 100 to generate authentication information on the identity authentication server 200, and provides the generated authentication information to the connected identity authentication server 200, as indicated by ‘\textcircled{4}’. At this time, the identity authentication server 200 performs an identity authentication using the user authentication information provided from the identity selector of the user terminal 100, and provides the identity authentication information of which authentication is completed to the web service providing server 300 through the web browser, as indicated by ‘\textcircled{5}’.

Meanwhile, when the web service providing server 300 receives the result of the corresponding user identity authentication through the web browser, it verifies the user identity based on the received result of the identity authentication. At this time, when the verification of the corresponding user identity is completed, the web service providing server 300 provides the web service requested by the user, as indicated by ‘\textcircled{6}’.

Hereinafter, the operation flow of the present invention will be described.

FIG. 7 is a flowchart showing a process when the user identity information is registered between the user terminal 100 and the identity authentication server 200.

Referring to FIG. 7, first the user terminal 100 is connected to the identity authentication server 200 through the web browser according to the user request and requests the registration of the identity authentication service (S500). At this time, the identity authentication server 200 requests the user identity information to the corresponding user terminal 100, in order to register the user identity information that requests the corresponding service (S510).

The user terminal 100 provides the user identity information to the identity authentication server 200 according to the request of the identity authentication server 200 (S520). At this time, the user identity information that is provided to the identity authentication server 200 may be one input from the user or one previously stored in the identity management module 130 of the user terminal 100.

The identity authentication sever 200 performs the user authentication using the user identity information provided from the user terminal 100 and allows the user identity information of which verification is completed to be registered (S530). Also, the identity authentication server 200 issues the identity authentication information on the registered user and allows it to be stored (S540). At this time, the issued identity authentication information includes virtual personal identification information that is provided to the corresponding web service providing server 300 when there is a request of user identity authentication from the web service providing server 300 later. As the virtual personal identification information, there are I-PIN, G-PIN or SAML service-based identification information, etc.

Also, the identity authentication information issued from the identity authentication server 200 includes log-in information of the corresponding identity authentication server 200, that is, ID and password. Also, the identity authentication information issued from the identity authentication server 200 may also include information such as an address of the identity authentication server 200, etc. and the certificate issued from the identity authentication server 200, etc.

Further, after the verification is completed, the identity authentication server 200 may also provide the identity selector that manages the identity information, in which the user is registered, while simultaneously transmitting a response message to the user terminal 100 (S550). Although the identity selector may be provided automatically from the identity authentication server 200, it may be provided separately according to the request from the user terminal 100. Of course, when the identity selector is already installed in the user terminal 100, a separate identity selector may not be provided.

When the registration of the identity authentication service into the identity authentication server 200 is completed, the user terminal 100 installs the identity selector provided from the identity authentication server 200 (S560). Thereafter, the user terminal 100 manages the user identity information to be managed using the identity selector (S570).

Therefore, while the corresponding user identity authentication is performed by the web service providing server 300, etc., the authentication information may be automatically provided even though the user does not input separate identity information, making it possible to prevent the user personal information from being leaked to the outside by keyboard hacking, etc. Also, the identity selector manages the user identity information according to the plurality of identity authentication servers 200 in which the users are registered, by advantageously improving user's convenience.

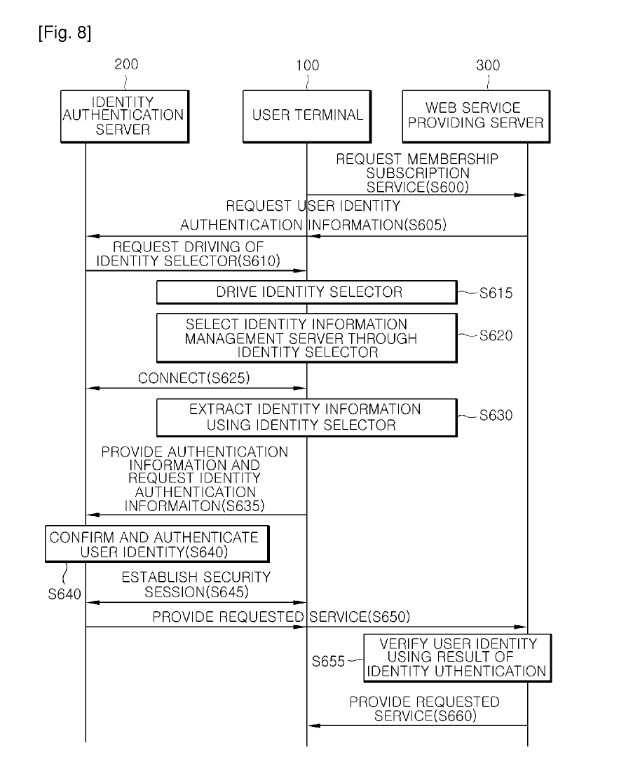

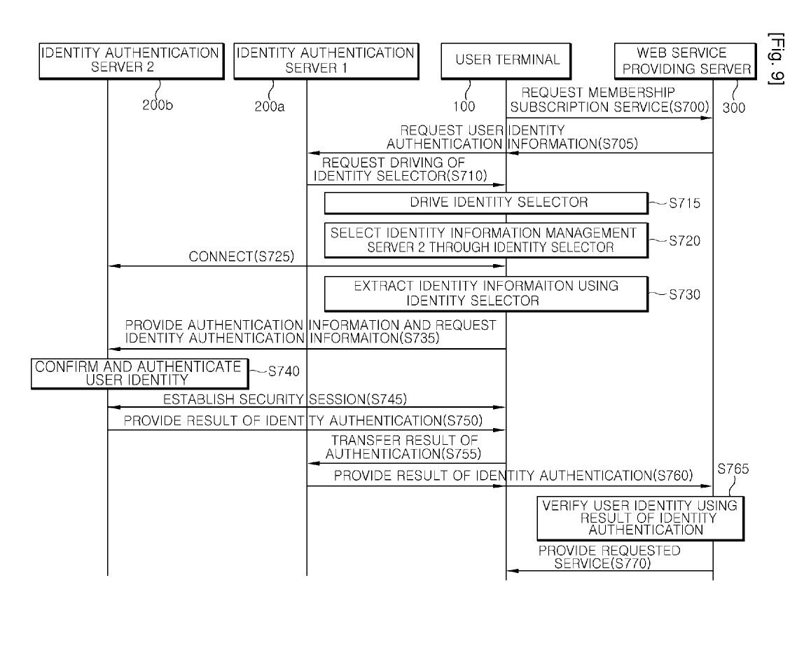

FIGS. 8 to 10 are flowcharts showing a process when the identity authentication is performed among the user terminal, the web service providing server, and the identity authentication server.

First, referring to FIG. 8, the user terminal 100 requests a membership subscription service using the virtual personal identification information issued from the identity authentication server 200 in order to use the web service of the web service providing server 300 (S600). At this time, the web service providing server 300 is connected to the identity authentication server 200 through the web browser to which the user terminal 100 is connected and requests the user identity authentication information for the user authentication (S605).

At this time, the identity authentication server 200 transmits an identity selector driving instruction to the corresponding user terminal 100 (S610). The user terminal 100 drives the identity selector module 150 according to the identity selector driving instruction of the identity authentication server 200 (S615). If the identity selector is operated, it extracts the information on the identity authentication server 200 in which the corresponding user is registered, that is, a list of the identity authentication server from the identity management module and outputs the extracted information

If any one identity authentication server 200 is selected (S620), the identity selector is connected to the corresponding identity authentication server 200 through the web browser (S625). The embodiment of FIG. 8 shows a case where the identity authentication server 200 to which the identity authentication is requested by the web service providing server 300 is selected.

Also, the identity selector extracts the user identity information corresponding to the connected identity authentication server 200 to generate authentication information, and transmits the generated authentication information to the corresponding identity authentication server 200 (S630 and S635). At this time, the identity authentication server 200 compares the user authentication information provided from the identity selector of the user terminal 100 with the registered corresponding user information and then confirms the corresponding user identity, thereby performing the authentication (S640).

When the corresponding user identity authentication is completed in the identity authentication server 200, the identity authentication server 200 establishes a security session between the identity authentication server 200 and the user terminal 100 (S645), and transfers the result of the corresponding user identity authentication to the web service providing server 300 through the web browser (S650) of the user terminal 100 (S650). At this time, the result of the identity authentication transferred to the web service providing server 300, which is authentication information that is issued when the user identity information is early registered in the identity authentication server 200, is provided in a recognizable shape in the corresponding web service providing server 300. As the result of the identity authentication, there is I-PIN or G-PIN, etc. by way of example.

Therefore, the web service providing server 300 verifies the corresponding user identity using the result of the user identity authentication provided from the identity authentication server 200 (S655), and allows the requested service to the verified user (S660). In other words, the web service providing server 300 performs the membership subscription procedure of the verified user. Thereafter, the web service providing server 300 provides the service requested by the user who has membership.

Meanwhile, FIG. 9 shows a case where an identity authentication server other than the identity authentication server 200 to which the identity authentication is requested by the web service providing server 300 in the step of ‘620 ’ in FIG. 8.

For convenience, in the present embodiment, the identity authentication server 200 to which the identity authentication is requested by the web service providing server 300 will be referred to as an ‘identity authentication server 1 200a’ and the identity authentication server 200 that is actually selected by the identity selector to perform the user identity authentication will be referred to as an ‘identity authentication server 2 200b’.

In other words, the user terminal 100 requests the membership subscription service using the virtual personal identification information issued from the identity authentication server 200 in order to use the web service of the web service providing server 300 (S700). At this time, the web service providing server 300 is connected to the identity authentication server 1 200a through the web browser to which the user terminal 100 is connected to request the user identity authentication information for the user authentication (S705).

At this time, the identity authentication server 1 200a transmits an identity selector driving instruction to the corresponding user terminal 100 (S710). The user terminal 100 drives the identity selector module 150 according to the identity selector driving instruction of the identity authentication server 1 200a.

If the identity selector is driven by the identity selector module 150 (S715), it extracts the information on the identity authentication server 200 in which the corresponding user is registered, that is, a list of the identity authentication server from the identity management module 130 and outputs the extracted information. If the identity authentication server 2 200b is selected by the user (S720), the identity selector is connected to the identity authentication server 2 200b through the web browser (S725).

At this time, the identity selector extracts the user identity information corresponding to the connected identity authentication server 2 200b to generate authentication information (S730), and transmits the generated authentication information to be transmitted to the identity authentication server 2 200b (S735). The identity authentication server 2 200b compares the user authentication information provided from the identity selector of the user terminal 100 with the registered corresponding user information and then confirms the corresponding user identity, thereby performs the authentication (S740).

When the corresponding user identity authentication is completed in the identity authentication server 2 200b, the identity authentication server 2 200b establishes a security session between the identity authentication server 2 200b and the user terminal 100 (S745). Thereafter, the identity authentication server 2 200b transmits the result of the corresponding user identity authentication to the web browser of the user terminal 100 (S750), and at this time, the identity selector transmits the result of the identity authentication received from the identity authentication server 2 200b to the identity authentication server 1 200a (S755).

At this time, the identity authentication server 1 200a changes the result of the corresponding user identity authentication transmitted from the identity authentication server 2 200b as a recognizable type in the web service providing server 300, and then provides it to the web service providing server 300 through the web browser of the user terminal 100 (S760).

The web service providing server 300 performs identity verification only through the user identity authentication information provided from the previously registered identity authentication server 200 (S765). Therefore, in the embodiment of FIG. 9, the user identity authentication is performed by the identity authentication server 2 200b, such that the result thereof is transmitted again to the identity authentication server 1 200a to allow the web service providing server 300 to recognize if the user authentication is performed in the identity authentication server 1 200a.

However, when the result of the identity authentication of the identity authentication server 2 200b is available in the web service providing server 300, the result of the corresponding user identity authentication may be transmitted from the identity authentication server 2 200b directly to the web service providing server 300 through the web browser of the user terminal 100.

Therefore, the web service providing server 300 verifies the corresponding user identity using the user identity authentication information provided from the identity authentication server 200 (S765), and allows the requested service to the verified user (S770). In other words, the web service providing server 300 performs the membership subscription procedure of the verified user. Thereafter, the web service providing server 300 provides the service requested by the user who has membership.

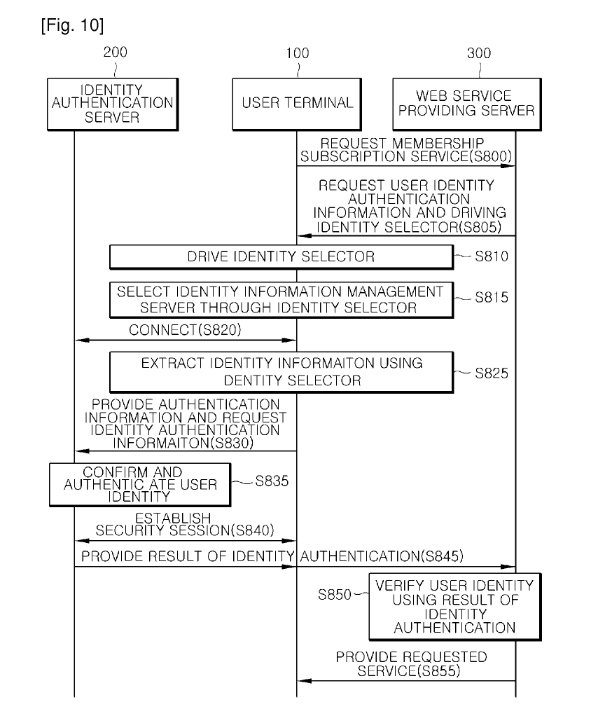

FIGS. 8 and 9 show a case where the identity selector of the user terminal is driven by the identity authentication server, whereas FIG. 10 shows a case where the identity selector of the user terminal is driven by the web service providing server 300 when the user terminal requests a membership subscription service to the web service providing server 300.

Referring to FIG. 10, the user terminal 100 requests the membership subscription service using the virtual personal identification information issued from the identity authentication server 200 in order to use the web service of the web service providing server 300 (S800). At this time, the web service providing server 300 requests the user identity authentication information to the user terminal 100 for the user authentication and at the same time, requests a driving of allows the identity selector of the user terminal 100 by the identity selector driving module 350 (S805).

The user terminal 100 drives the identity selector module 150 according to the request of the web service providing server 300.

If the identity selector 150 is driven by the identity selector module 150 (S815), it extracts the information on the identity authentication server 200 in which the corresponding user is registered, that is, a list of the identity authentication server from the identity management module 130 and outputs the extracted information If any one identity authentication server 200 is selected (S815), the identity selector is connected to the corresponding identity authentication server 200 through the web browser (S820).

Like FIG. 8, FIG. 10 describes a case where the identity authentication server 200 to which the identity authentication is requested by the web service providing server 300 by way of example. In the case where the identity authentication server 200 not registered in the web service providing server 300 is selected by the identity selector, see processes ‘720’ to ‘760’ in FIG. 9.

The identity selector extracts the user identity information corresponding to the connected identity authentication server 200 to generate authentication information, and transmits the generated authentication information to the corresponding identity authentication server 200 (S825 and S830). At this time, the identity authentication server 200 compares the user authentication information provided from the identity selector of the user terminal 100 with the registered corresponding user information and then confirms the corresponding user identity, thereby performs the authentication (S835).

When the corresponding user identity authentication is completed in the identity authentication server 200, the identity authentication server 200 establishes a security session between the identity authentication server 200 and the user terminal 100 (S840), and transmits the result of the corresponding user identity authentication to the web service providing server 300 through the web browser of the user terminal 100 (S845).

At this time, the result of the identity authentication transferred to the web service providing server 300, which is authentication information that is issued when the user identity information is registered beforehand in the identity authentication server 200, is provided as recognizable data in the corresponding web service providing server 300.

Therefore, the web service providing server 300 performs the corresponding user identity verification using the result of the user identity authentication provided from the identity authentication server 200 (S850), and allows the requested service to the verified user (S855). In other words, the web service providing server 300 performs the membership subscription procedure of the verified user. Thereafter, the web service providing server 300 provides the service requested by the user who has membership.

The user terminal 100 with the identity selector and the method for identity authentication using the identity selector of the same according to the present invention as described above are not limited to the constitution and the method of the embodiments as described above, but the entirety or the portions of the respective embodiments my be selectively combined so that the embodiments can be variously modified.

1. A user terminal with an identify selector that provides identity information for a user identity authentication between an identity authentication server and a web service providing server, comprising:
an identity management module that stores and manages information of identity authentication server that issues virtual personal identification information for a corresponding user and the corresponding user identity information; and
when a web service using the virtual personal identification information is requested to the web service providing server, an identity selector module that controls driving of the identity selector that provides authentication information generated based on the corresponding user identity information stored in the identity management module to the identity authentication server, while the corresponding user identity authentication is performed between the user terminal and the identity authentication server according to the request from the web service providing server.

2. The user terminal with the identify selector according to claim 1, wherein the virtual personal identification information includes at least one of Internet-Personal Identification Number (I-PIN), Government Personal Identification Number (G-PIN), and Security Assertion Markup Language (SAML)-based authentication information.

3. The user terminal with the identify selector according to claim 1, wherein the user identity information includes at least one of log-in information and the virtual personal identification information issued from the identity authentication server, and the corresponding user personal information.

4. The user terminal with the identify selector according to claim 1, wherein the user identity information is stored to correspond to each of the identity authentication servers that issues the virtual personal identification information to the corresponding user.

5. The user terminal with the identify selector according to claim 1, wherein when a web service is requested to the web service providing server using the virtual personal identification information, the identity selector module is driven according to the request of the identity authentication server to which the identity authentication is requested by the web service providing server.

6. The user terminal with the identify selector according to claim 1, wherein when a web service is requested to the web service providing server using the virtual personal identification information, the identity selector module is driven according to the request of the web service providing server.

7. The user terminal with the identify selector according to claim 1, wherein the identity selector outputs a list of the identity authentication server registered in the identity management module and is requested to be connected to any one identity authentication server selected from the list of the identity authentication server.

8. The user terminal with the identify selector according to claim 1, wherein when the corresponding user identity authentication is completed in the identity authentication server, the identity selector transfers the result of the identity authentication provided from the identity authentication server to the web service providing server.

9. A method for an identity authentication using an identity selector of a user terminal that performs the identity authentication using the identity selector between an identity authentication server and a web service providing server, comprising:
requesting a web service to the web service providing server using virtual personal identification information issued from the identity authentication server;
when the web service providing server requests a corresponding user identity authentication from the web service providing server, driving the identity selector by request of the identity authentication server;
transmitting an authentication information from the identity selector to the identity authentication server, the authentication information being generated based on the corresponding user identity information registered by the corresponding identity authentication server; and
when the corresponding user identity authentication is completed in the identity authentication server using the identity information transmitted in the transmitting the authentication information, receiving the requested service by transmitting the result of the identity authentication of the identity authentication server to the web service providing server.

10. The method for the identity authentication using the identity selector of the user terminal according to claim 9, wherein the virtual personal identification information includes at least one of Internet-Personal Identification Number (I-PIN), Government Personal Identification Number (G-PIN), and Security Assertion Markup Language (SAML)-based authentication information.

11. The method for the identity authentication using the identity selector of the user terminal according to claim 9, wherein the user identity information includes at least one of log-in information and the virtual personal identification information issued from the identity authentication server, and the corresponding user personal information.

12. The method for the identity authentication using the identity selector of the user terminal according to claim 9, wherein the user identity information is stored to correspond to each of the identity authentication servers that issues the virtual personal identification information to the corresponding user.

13. The method for the identity authentication using the identity selector of the user terminal according to claim 9, further comprising: before the requesting the web service,
connecting a corresponding user terminal to the identity authentication server;
providing the corresponding user identity information to the identity authentication server and being performed a corresponding user identity authentication by the identity authentication server; and
after the identity authentication of the identity authentication server is completed, storing log-in information and virtual personal identification information issued from the identity authentication server in the corresponding user terminal.

14. The method for the identity authentication using the identity selector of the user terminal according to claim 9, further comprising: after the driving the identity selector,
extracting and outputting a list of the identity authentication server stored in the corresponding user terminal; and
requesting connection to one selected among the list of the identity authentication server.

15. The method for the identity authentication using the identity selector of the user terminal according to claim 14, wherein the transmitting the authentication information includes:
when the selected identity authentication server is different from an identity authentication server to which the web service providing server requested the identity authentication,
transmitting the result of the identity authentication of the corresponding identity authentication server from the identity selector to the identity authentication server to which the identity authentication is requested by the web service providing server; and
based on the transmitted result of the identity authentication, transmitting the result of the identity authentication issued from the identity authentication server to which the identity authentication is requested by the web service providing server to the web service providing server.
